(19) United States
(12) Patent Application Publication
(10) Pub. No.: US 2017/0072604 A1
(43) Pub. Date: Mar. 16, 2017

(54) COMPOSITE FOAM AND METHODS OF PREPARATION AND USE

(71) Applicant: EMPIRE TECHNOLOGY DEVELOPMENT LLC, Wilmington, DE (US)

(72) Inventor: Angele SJONG, Louisville, CO (US)

(73) Assignee: EMPIRE TECHNOLOGY DEVELOPMENT LLC, Wilmington, DE (US)

(21) Appl. No.: 15/125,523

(22) PCT Filed: Mar. 10, 2014
(86) PCT No.: PCT/US14/22720

§ 371 Date: Sep. 12, 2016

(51) Int. Cl. B29C 44/34; B29C 44/02

(52) U.S. Cl. CPC B29C 44/3469; B29C 44/022; B29K 2105/04

(57) ABSTRACT

Composite foams having cells containing shape-stabilized phase change material (ss-PCM) particles are described. Composite foams may be made by contacting a plurality of ss-PCM particles and one or more pre-polymer reactants, wherein each ss-PCM particle can form a nucleation site for foam cell generation. The composite foams may be used in regulating the temperature of an article wherein the foam undergoes a phase transition as the surrounding temperature of the article approaches the foam's phase transition temperature. The thermostatic material may exchange heat with the article during the phase transition, resulting in regulation of the temperature of the article. The composite foams may be used as a thermostatic packaging material having a cavity for storing goods.

### BACKGROUND

Polymer foams are used in a variety of industries, with selection of use based largely on the physical properties of the foams. For instance, the thermostatic properties of some polymer foams make them particularly useful as food packaging materials.

Polymer foam properties can be dependent on foam morphology including foam cell density, size, and size distribution. Therefore, methods of controlling polymer foam properties by altering the foam morphology will be desired to configure polymer foams for use in a wide array of applications.

### SUMMARY

In an embodiment, a composite foam may include a plurality of foam cells and a plurality of shape-stabilized phase change material (ss-PCM) particles.

In an embodiment, a method of making a composite foam may include providing a plurality of shape-stabilized phase change material (ss-PCM) particles; providing one or more pre-polymer reactants; and contacting the plurality of ss-PCM particles and the one or more pre-polymer reactants under conditions to form a composite foam, wherein each of the ss-PCM particles form a nucleation site for cell generation within the composite foam.

In an embodiment, a method of regulating the temperature of an article may include using a thermostatic material made of a polymeric foam having a plurality of foam cells and a plurality of ss-PCM particles, wherein at least one of the plurality of ss-PCM particles resides within at least one of the plurality of cells, and wherein the thermostatic material undergoes a phase transition as the surrounding temperature of the article approaches a phase transition temperature of the thermostatic material. The thermostatic material may exchange heat with the article during the phase transition, resulting in regulation of the temperature of the article.

In an embodiment, a thermostatic packaging material may include a thermostatic material defining a cavity for storing goods, wherein the thermostatic material is configured to regulate the temperature within the cavity. The thermostatic material includes a polymeric foam having a plurality of foam cells and a plurality of ss-PCM particles residing within at least one of the plurality of foam cells.

### BRIEF DESCRIPTION OF THE DRAWINGS

The drawings submitted herewith show some embodiments or features of some embodiments encompassed by the disclosure. The drawings are meant to be illustrative and are not intended to be limiting.

FIG. 1 depicts a polymeric foam having a plurality of foam cells containing ss-PCM particles.

FIG. 2 depicts a thermostatic packaging material.

### DETAILED DESCRIPTION

This disclosure is not limited to the particular systems, devices, and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this document, the respective meanings set forth below.

The described technology generally relates to composite foams and methods of making and using the composite foams. The composite foam may include a polymeric foam having a plurality of cells, and a plurality of shape-stabilized phase change material (ss-PCM) particles, wherein at least one of the plurality of ss-PCM particles resides within at least one of the plurality of cells. In particular, some embodiments provide thermostatic and/or biodegradable composite foams that can be used in a variety of industries. For instance, some embodiments provide composite foams that may be used in food packaging, shipping materials, and/or building materials.

As used herein, “shape-stabilized phase change material” (ss-PCM) refers to a phase change material that is prevented from losing shape when it melts.

Foam morphology, and the properties of a polymeric foam, can be controlled using nanofillers that act as heterogeneous sites to decrease foam cell size and to reinforce the polymeric matrix. The presence of nano-sized fillers can decrease the energy barrier for cell nucleation as compared to the energy required for homogeneous nucleation. This may then force the nucleation to occur at the filler-polymer interface and result in a narrow cell size distribution.

A ss-PCM may be used to form a biodegradable, thermostatic, and/or insulative polymeric foam. The ss-PCM may function as a heterogeneous nucleation site during supercritical gas foam production and may cause a decreased foam cell size, a uniform foam cell size, and/or an increased overall number of closed foam cells. As the thermal conductivity of most polymeric foams can be directly related to foam cell volume and thermal conductivity of the gas inside the foam cells (as opposed to the thermal conductivity of the polymer), providing a ss-PCM particle in each foam cell may greatly increase the thermal insulative properties of the polymeric foam. Radiative heat transfer is also a source of conductivity, which may be reduced by reducing foam cell size and/or increasing radiation absorption through the use of fillers such as infrared light absorbing fillers. ss-PCM particles can be effective in decreasing thermal conductivity of polymeric foams possibly due to a smaller foam cell size and/or a slowing of the diffusion of foaming agents from foam cells to the atmosphere.

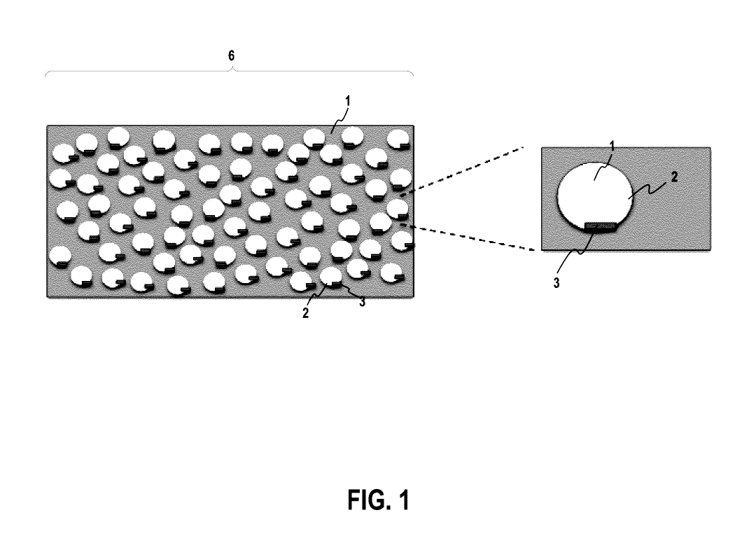

Disclosed herein are composite foams, and methods of making and using such composite foams. As shown in FIG. 1, in some embodiments, a composite foam 1 is a polymeric foam having a plurality of cells 2 and a plurality of shape-stabilized phase change material (ss-PCM) particles 3, wherein at least one of the plurality of ss-PCM particles 3 resides within at least one of the plurality of cells 2.

In some embodiments, the composite foam is a heterogeneous foam. In some embodiments, the composite foam is biodegradable. In some embodiments, the composite foam is thermostatic. The composite foam can be a closed cell foam, and/or an open cell foam, or both.

The amount of ss-PCM particles in the composite foam can vary. In some embodiments, the plurality of ss-PCM particles may be present in the composite foam in an amount of up to about 50 weight percent. In some embodiments, the plurality of ss-PCM particles may be present in the composite foam in an amount of up to about 15 weight percent. For example, the plurality of ss-PCM particles may be present in the composite foam in an amount of about 5% by weight, about 10% by weight, about 15% by weight, about 20% by weight, about 25% by weight, about 30% by weight, about 35% by weight, about 40% by weight, about 45% by weight, about 50% by weight, or any weight percent or range of weight percent greater than 0 and up to and including about 50 weight percent.

In some embodiments, the plurality of ss-PCM particles are nanoparticles. In some embodiments, the plurality of ss-PCM particles have at least one dimension that is less than or equal to about 100 nanometers. For example, the at least one dimension can be about 100 nanometers, about 80 nanometers, about 60 nanometers, about 40 nanometers, about 20 nanometers, or a dimension between any of the listed values.

In some embodiments, the plurality of ss-PCM particles may be modified with at least one agent. For example, the ss-PCM particles may be modified with at least one of tridecafluoro-1,1,2,2-tetrahydrooctyl silane, glycidyl phenyl ether, 3-(trimethoxysilyl)-propyl methacrylate, 2-methacryloyloxyethylhexadecyldimethylammonium bromide, dibutyldimethoxytin, and/or sodium hypochlorite solution. In some embodiments, the plurality of ss-PCM particles may be modified with a surfactant such as an alkylammonium surfactant, a vinyl-ammonium surfactant, or combinations thereof. The alkylammonium surfactant may have, for example, a carbon chain length of about 2 to about 30 carbon atoms, a carbon chain length of about 15 to about 20 carbon atoms or a carbon chain length of about 16 to about 18 carbon atoms, or any range between any two of these values (including endpoints). For example, the carbon chain length can have about 2 carbon atoms, 4 carbon atoms, 6 carbon atoms, 8 carbon atoms, 10 carbon atoms, 12 carbon atoms, 14 carbon atoms, 16 carbon atoms, 18 carbon atoms, 20 carbon atoms, or a number between any of these values. In some embodiments, the ss-PCM particles may be modified with hexadecylammonium chloride.

In some embodiments, the plurality of ss-PCM particles may include a nanofiller as shape stabilizer and a phase change material.

In some embodiments, the nanofiller has at least one dimension that is less than or equal to about 100 nanometers. For example, the at least one dimension can be about 100 nanometers, about 80 nanometers, about 60 nanometers, about 40 nanometers, about 20 nanometers, or a dimension between any of the listed values. In some embodiments, the nanofiller is spherical-shaped, platelet-shaped, tube-shaped, or rod-shaped. In some embodiments, the phase change material is contained substantially within the nanofiller.

The nanofiller may include a variety of materials. For instance, the nanofiller may include clay, silicate, aluminosilicate clay, graphene, graphene oxide, porous graphene oxide, expanded graphite, silicon dioxide composite, halloysite, halloysite nanotube, porous halloysite nanotube, sodium montmorillonite, vinyl-modified silica, carbon, carbon nanotube, carbon nanofiber, calcium silicate, nano-structured calcium silicate, or combinations thereof.

In some embodiments, the nanofiller may be a clay. In some embodiments, the clay may have a cation exchange capacity of about 0% to about 200%. In some embodiments, the clay may have a cation exchange capacity of about 0%, a cation exchange capacity of about 100%, or a cation exchange capacity of about 200%, or any range between any two of these values. For example, the clay may have a cation exchange capacity of about 0%, about 20%, about 40%, about 60%, about 80%, about 100%, about 120%, about 140%, about 160%, about 180%, about 200%, or a percentage between any of these values.

In some embodiments, the nanofiller may be sodium montmorillonite. In some embodiments, the cation exchange capacity may be up to about 200 milliequivalents per 100 grams of sodium montmorillonite. In some embodiments, the cation exchange capacity may be about 92.6 milliequivalents per 100 grams of sodium montmorillonite.

In some embodiments, the clay may be modified with at least one agent. For example, the clay may be modified with at least one of tridecafluoro-1,1,2,2-tetrahydrooctyl silane, glycidyl phenyl ether, 3-(trimethoxysilyl)-propyl methacrylate, 2-methacryloyloxyethylhexadecyldimethylammonium bromide, dibutyldimethoxytin, and/or sodium hypochlorite solution. In some embodiments, the clay may be modified with a surfactant such as an alkylammonium surfactant, a vinyl-ammonium surfactant, or combinations thereof. The alkylammonium surfactant may have, for example, a carbon chain length of about 2 to about 30 carbon atoms, a carbon chain length of about 15 to about 20 carbon atoms, a carbon chain length of about 16 to about 18 carbon atoms, or any range between any two of these values. For example, the carbon chain length can have about 2 carbon atoms, 4 carbon atoms, 6 carbon atoms, 8 carbon atoms, 10 carbon atoms, 12 carbon atoms, 14 carbon atoms, 16 carbon atoms, 18 carbon atoms, 20 carbon atoms, 22 carbon atoms, 24 carbon atoms, 26 carbon atoms, 28 carbon atoms, 30 carbon atoms, or a number between any of these values. In some embodiments, the clay may be modified with hexadecylammonium chloride.

In some embodiments, the nano-filler may be organic. In some embodiments, the nano-filler may be inorganic.

The phase change material may include a variety of materials. For instance, the phase change material may include an alkane, a salt hydrate, a fatty acid, a paraffin, a paraffin oil, a paraffin wax, organic eutectic, inorganic eutectic, eicosan, 1-dodecanol, 1-tetradecanol, polyglycol E6000, polyglycol E600, propionamide, or naphthalene, or combinations thereof. In some embodiments, for example, the phase change material may include urea in an amount of about 50% by weight, and acetamide in an amount of about 50% by weight. In some embodiments, for example, the phase change material may include urea in an amount of about 37.5% by weight, and acetamide in an amount of about 63.5% by weight. For example, the phase change material may include urea in an amount of about 20% by weight, about 22% by weight, about 24% by weight, about 26% by weight, about 28% by weight, about 30% by weight, about 32% by weight, about 34% by weight, about 36% by weight, about 38% by weight, about 40% by weight, about 42% by weight, about 44% by weight, about 46% by weight, about 48% by weight, about 50% by weight, or any percentage between any of these values. For example, the phase change material may include acetamide in an amount of about 50% by weight, about 52% by weight, about 54% by weight, about 56% by weight, about 58% by weight, about 60% by weight, about 62% by weight, about 64% by weight, about 66% by weight, about 68% by weight, about 70% by weight, about 72% by weight, about 74% by weight, about 76% by weight, about 78% by weight, about 80% by weight, or any percentage between any of these values. In some embodiments, the phase change material may include benzoic acid in an amount of about 50% by weight, and naphthalene in an amount of about 50% by weight. In some embodiments, the phase change material comprises benzoic acid in an amount of about 32.9% by weight, and naphthalene in an amount of about 67.1% by weight. For example, the phase change material may include benzoic acid in an amount of about 20% by weight, about 22% by weight, about 24% by weight, about 26% by weight, about 28% by weight, about 30% by weight, about 32% by weight, about 34% by weight, about 36% by weight, about 38% by weight, about 40% by weight, about 42% by weight, about 44% by weight, about 46% by weight, about 48% by weight, about 50% by weight, or any percentage between any of these values. For example, the phase change material may include naphthalene in an amount of about 50% by weight, about 52% by weight, about 54% by weight, about 56% by weight, about 58% by weight, about 60% by weight, about 62% by weight, about 64% by weight, about 66% by weight, about 68% by weight, about 70% by weight, about 72% by weight, about 74% by weight, about 76% by weight, about 78% by weight, about 80% by weight, or any percentage between any of these values.

In some embodiments, the phase change material may include an alkane, a salt hydrate, a fatty acid, or combinations thereof. In some embodiments, the phase change material may include a paraffin, a paraffin oil, a paraffin wax, or combinations thereof.

In some embodiments, the nanofiller may be a nanotube. In some embodiments, the nanofiller may be impregnated with the phase change material. In some embodiments, the nanofiller may be halloysite.

The polymeric foam may include a variety of materials. In some embodiments, the polymeric foam may include poly(methyl methacrylate), polylactide, poly-DL-lactide, poly(D,L lactic acid), poly(L-lactic acid), polyurethane, polystyrene, poly(vinyl chloride), polycaprolactone, polyethylene, polyetherimide, polymethyacrylimide, a fluorocarbon elastomer, or combinations thereof.

In some embodiments, the composite foam may have a thermal conductivity of about 0.010 to about 0.100 W/m-K. In some embodiments, the composite foam has a thermal conductivity of less than about 0.050 W/m-K. In some embodiments, the composite foam has a thermal conductivity of less than about 0.030 W/m-K. In some embodiments, the composite foam has a thermal conductivity of about 0.010 W/m-K, a thermal conductivity of about 0.030 W/m-K, a thermal conductivity of about 0.050 W/m-K, or a thermal conductivity of about 0.100 W/m-K, or any range between any two of these values.

In some embodiments, the plurality of ss-PCM particles are configured as a plurality of heterogeneous nucleation sites for formation of the plurality of cells.

The composite foam described herein may be used for a variety of applications. For instance, the composite foam may be a component in at least one of the following: food packaging, thermal insulation materials, thermostatic packaging materials, building materials, solar energy storage materials, airplane building materials, automobile building materials, vehicle building materials, flammability resistant materials, textiles, green house materials, solar energy system materials, cushion materials, absorbent materials, hydrogen storage materials, electromagnetic shielding materials, sensor materials, sound barrier materials, shock absorbing materials, tissue engineering scaffold materials, microelectronic materials, acoustic dampening materials, sporting equipment materials, energy conversion materials, lining materials, thermal buffering materials, insulation materials, energy conservation materials, conductive foam materials, electromagnetic interference shielding materials, body protection apparel materials, sound insulation materials, electrostatic discharge protection materials, lightning-protection panel materials, and gas impermeable materials.

Disclosed herein are methods of making a composite foam. A method of making a composite foam may include providing a plurality of ss-PCM particles, providing one or more pre-polymer reactants, and contacting the plurality of ss-PCM particles and the one or more pre-polymer reactants under conditions to form a composite foam. In some embodiments, each of the plurality of ss-PCM particles forms a nucleation site for cell generation within the composite foam.

In some embodiments, the plurality of ss-PCM particles and the one or more pre-polymer reactants may be contacted with a supercritical gas. In some embodiments, the supercritical gas may include at least one of carbon dioxide, cyclopentane, and/or isopentane.

The described methods can be used to make composite foams as described herein.

Described herein are methods of regulating the temperature of at least one article. A method of regulating the temperature of an article may include providing a thermostatic material, wherein the thermostatic material may include a polymeric foam comprising a plurality of cells, and a plurality of shape-stabilized phase change material (ss-PCM) particles. In some embodiments, at least one of the plurality of ss-PCM particles resides within at least one of the plurality of cells. In some embodiments, the thermostatic material may undergo a phase transition as the surrounding temperature of the article approaches the phase transition temperature of the thermostatic material. In some embodiments, the thermostatic material may exchange heat with the article during the phase transition to regulate temperature of the article. In some embodiments, the thermostatic material is a heterogeneous foam containing the plurality of ss-PCM particles.

In some embodiments, the method of regulating the temperature of at least one article involves ss-PCM particles that are configured as a plurality of heterogeneous nucleation sites for the formation of the plurality of cells.

In some embodiments, the method of regulating the temperature of at least one article involves providing a thermostatic material that may be a component in, for example, at least one of the following: food packaging, thermal insulation materials, thermostatic packaging materials, building materials, solar energy storage materials, airplane building materials, automobile building materials, vehicle building materials, flammability resistant materials, textiles, green house materials, solar energy system materials, cushion materials, absorbent materials, hydrogen storage materials, electromagnetic shielding materials, sensor materials, sound barrier materials, shock absorbing materials, tissue engineering scaffold materials, microelectronic materials, acoustic dampening materials, sporting equipment materials, energy conversion materials, lining materials, thermal buffering materials, insulation materials, energy conservation materials, conductive foam materials, electromagnetic interference shielding materials, body protection apparel materials, sound insulation materials, electrostatic discharge protection materials, lightning-protection panel materials, and gas impermeable materials.

The described methods can be practiced using composite foams as described herein.

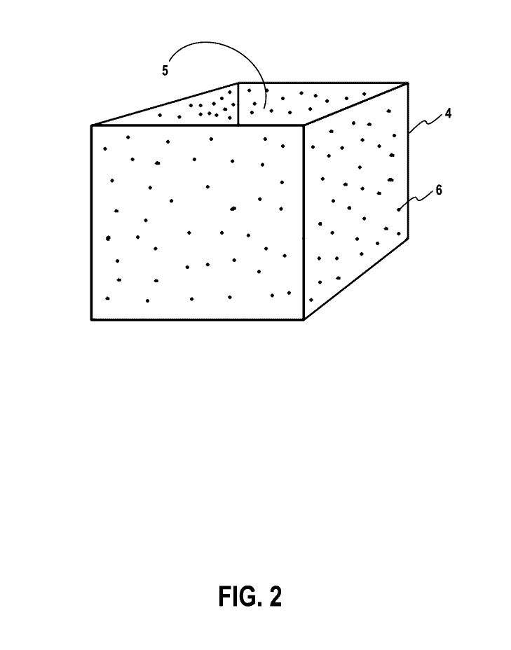

Described herein are thermostatic packaging materials, a non-limiting example of which is shown in FIG. 2. In some embodiments, a thermostatic packaging material 4 includes a thermostatic material defining a cavity 5 for storing goods, wherein the thermostatic material may be configured to regulate temperature within the cavity 5. In some embodiments, the thermostatic material 4 may include a polymeric foam 6 having a plurality of cells, and a plurality of shape-stabilized phase change material (ss-PCM) particles. In some embodiments, at least one of the ss-PCM particles resides within at least one of the cells. In some embodiments, the thermostatic packaging material 4 may be a container, a bag, an envelope, a box, or a tube.

The described thermostatic packaging materials may include composite foams as described herein.

### EXAMPLES

### Example 1

### Biodegradable Composite Foam—Halloysite Nanotubes with No Surfactant Treatment

A biodegradable composite foam is produced by first impregnating porous halloysite nanotubes with paraffin. The impregnated halloysite nanotubes are then subjected to 50 melt-freeze cycles and no leakage of the paraffin is observed. The impregnated halloysite nanotubes are contacted with polylactide and supercritical foaming with CO₂ is performed. The impregnated halloysite nanotubes are present in the foam in an amount of about 15 percent by weight. The foam produced is biodegradable and has thermostatic properties. Properties of the foam are determined by differential scanning calorimetry (DSC), thermogravimetric analysis, x-ray diffraction. For morphological characterization, an optical microscope and cross-sectioning of foam is used to determine pore diameter average; cell density and scale for foam density.

Impregnation of Halloysite Nanotubes with PCM.

The HNT and PCM is mixed in toluene solution at a weight ratio of 40:60, 70:30, irradiated ultrasonically for 90 minutes, then the toluene is recovered by stirring and refluxing under 80° C. for 2 h in a water bath. The HNT-PCM mixture is dried at 80° C. The HNT is optionally modified with surfactants prior to PCM loading using ion exchange reaction with alkyl ammonium surfactants. One example is hexadecylammonium chloride, from 50 to 200% of the HNT cation exchange capacity.

Preparation of Lactic Acid-HNT-PCM Composite Film.

Melt intercalation of HNT-PCM (optionally modified with hexadecylammonium chloride) is performed using a co-rotating twin screw microextruder/compounder. The compounding is conducted at 250 rpm and 130° C. for 25 minutes under nitrogen flow. The composite films are fabricated from a polylactide solution loaded with HNT-PCM and solution cast. The sample may also be extrusion cast. For either casting, the samples are formed as compression molded films (90° C. and 100 bar) to 0.75 mm.

Foaming of the Polylactic Acid Composite Film by Supercritical Fluid Processing

The HNT-PCM-polylactic acid film is foamed using the batch foaming technique (pressure quench) using supercritical CO₂ as a blowing agent. The compression molded HNT-PCM-PDLLA is placed in the high pressure vessel under CO₂ atmosphere at 120 bar or 150 bar and 45° C. for at least 4 h. The system is quenched to a supersaturated state by rapid depressurization (in less than 10 seconds).

### Example 2

### Biodegradable Composite Foam—Halloysite Nanotubes with Surfactant Treatment

A biodegradable composite foam is produced by first impregnating porous halloysite nanotubes with paraffin. The impregnated halloysite nanotubes are treated with an about 3 weight percent vinyl or alkylammonium surfactant having a carbon chain length of 14 to 16 carbons by ion exchange then subjected to 50 melt-freeze cycles. No leakage of the paraffin is observed. The impregnated halloysite nanotubes are contacted with polylactide and supercritical foaming with CO₂ is performed. The impregnated halloysite nanotubes are present in the foam in an amount of about 15 percent by weight. The foam produced is biodegradable and has thermostatic properties.

The foam's thermal conductivity can be measured in units of W m⁻¹ K⁻¹ using a heat flow apparatus. The microstructure is examined as a cross section under a microscope or using scanning electron microscopy to determine cell size and density. Cell gas composition is determined using GC/MS.

Biodegradability of the foam is tested as follows. A 500-ml Erlenmeyer flask is filled with 200 g of synthesized waste which contains equivalent weights of yard waste, kitchen garbage, paper waste, dry dog-food, dewatered sludge and soil and compacted to a density of 500 g-wet waste. The flask is equipped with an air-injection tube system at the center of the waste bottom. Traditional anaerobic waste landfill (TL) is simulated by the flask without aeration, while a landfill applying aeration is simulated by the flask with 150 ml of forced aeration (AL). In the AL reactor, water addition at intervals is coupled with aeration to prevent over-drying of the waste. A piece of plastic film is placed in the middle of each reactor. Twelve reactors are prepared for one experiment, two of which are used to investigate plastic degradation and to enumerate microbes at certain intervals. Physical measurements of polymer degradation are performed periodically and may include molecular weight measurements using inherent viscosity or gel permeation chromatography (GPC) testing.

### Example 3

### Biodegradable Composite Foam—Nano-Structured Calcium Silicate

A biodegradable composite foam is produced using nano-structured calcium silicate with a paraffin phase change material. The nano-structured calcium silicate with paraffin is contacted with polylactide and supercritical foaming with CO₂ is performed. The nanostructured calcium silicate is particles comprised of nanoplatelets, a highly porous material. It is prepared by reaction of Ca⁺² with the silicate anion, H₃SiO₄⁻ at room temperature under alkaline conditions at a pH typically about 11, according to the following equation:

Ca²H₃SiO₄OHCaSiOₓ(OH)_{y}H₂O Where x 2 and y≈2

The nano-structured calcium silicate with paraffin is present in the foam in an amount of about 15 percent by weight. The foam produced is biodegradable and had thermostatic properties.

### Example 4

### Biodegradable Composite Foam—Porous Silica

A biodegradable composite foam is produced by first modifying porous silica with n-(2-aminoethyl)-3-aminopropyltrimethoxysilane as a coupling agent. After modification, the PCM is added. The PCM is a fatty acid chosen based on the melting point most useful for the specific application. The impregnated nanotubes are contacted with polylactide and supercritical foaming with CO₂ is performed. The impregnated nanotubes are present in the foam in an amount of about 15 percent by weight. The foam produced is biodegradable and has thermostatic properties.

### Example 5

### Method of Regulating the Temperature of an Article/Good Using a Thermostatic Packaging Material

The temperature of an article/good is regulated by surrounding the article with any one of the thermostatic material made of a biodegradable composite foam as described in Examples 1 to 4 above. The thermostatic material is shaped such that it has a cavity. An article/good is placed in the cavity of the thermostatic material, thereby allowing the thermostatic material to maintain a relatively constant temperature of the article/good placed in the cavity despite any temperature changes around the outside of the thermostatic material.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and so forth. As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A thermostatic packaging material comprising:
a composite foam having:
a polymeric foam comprising a plurality of cells; and
a plurality of shape-stabilized phase change material (ss-PCM) particles, wherein at least one of the plurality of ss-PCM particles resides within at least one of the plurality of cells.

2. The thermostatic packaging material of claim 1, wherein the composite foam includes one or more of a heterogeneous foam a biodegradable foam, a closed-cell foam, and an open-cell foam.

3.-6. (canceled)

7. The thermostatic packaging material of claim 1, wherein the plurality of ss-PCM particles are present in the composite foam in an amount of up to about 50 weight percent.

8. (canceled)

9. The thermostatic packaging material of claim 1, wherein the plurality of ss-PCM particles have at least one dimension that is less than or equal to about 100 nanometers.

10. The thermostatic packaging material of claim 1, wherein the plurality of ss-PCM particles are modified with an agent selected from the group consisting of an alkylammonium surfactant and a vinyl-ammonium surfactant.

11.-16. (canceled)

17. The thermostatic packaging material of claim 1, wherein the plurality of ss-PCM particles comprise a nanofiller and a phase change material.

18.-20. (canceled)

21. The thermostatic packaging material of claim 17, wherein the nanofiller is clay, silicate, aluminosilicate clay, graphene, graphene oxide, porous graphene oxide, expanded graphite, silicon dioxide composite, halloysite, halloysite nanotube, porous halloysite nanotube, sodium montmorillonite, vinyl-modified silica, carbon, carbon nanotube, carbon nanofiber, calcium silicate, nano-structured calcium silicate, or combinations thereof.

22.-25. (canceled)

26. The thermostatic packaging material of claim 17, wherein the nanofiller includes a clay modified with an agent.

27. (canceled)

28. The thermostatic packaging material of claim 26, wherein the agent is a surfactant selected from an alkylammonium surfactant, a vinyl-ammonium surfactant or combinations thereof.

29.-31. (canceled)

32. The thermostatic packaging material of claim 26, wherein the agent is hexadecylammonium chloride.

33.-34. (canceled)

35. The thermostatic packaging material of claim 17, wherein the phase change material is an alkane, a salt hydrate, a fatty acid, a paraffin, a paraffin oil, a paraffin wax, organic eutectic, inorganic eutectic, eicosan, 1-dodecanol, 1-tetradecanol, polyglycol E6000, polyglycol E600, propionamide, or naphthalene, or combinations thereof.

36.-39. (canceled)

40. The thermostatic packaging material of claim 17, wherein the phase change material is an alkane, a salt hydrate, a fatty acid, or combinations thereof.

41. (canceled)

42. The thermostatic packaging material of claim 17, wherein the nanofiller is a nanotube.

43. The thermostatic packaging material of claim 17, wherein the nanofiller is impregnated with the phase change material.

44. (canceled)

45. The thermostatic packaging material of claim 1, wherein the polymeric foam comprises poly(methyl methacrylate), polylactide, poly-DL-lactide, poly(D,L lactic acid), poly(L-lactic acid), polyurethane, polystyrene, poly(vinyl chloride), polycaprolactone, polyethylene, polyetherimide, polymethyacrylimide, a fluorocarbon elastomer, or combinations thereof.

46. The thermostatic packaging material of claim 1, wherein the composite foam has a thermal conductivity of about 0.010 to about 0.100 W/m-K.

47.-48. (canceled)

49. The thermostatic packaging material of claim 1, wherein the plurality of ss-PCM particles are configured as a plurality of heterogeneous nucleation sites for formation of the plurality of cells.

50. (canceled)

51. A method of making a composite foam, the method comprising:
providing a plurality of shape-stabilized phase change material (ss-PCM) particles;
providing one or more pre-polymer reactants; and
contacting the plurality of ss-PCM particles and the one or more pre-polymer reactants under conditions to form a composite foam, wherein each of the plurality of ss-PCM particles forms a nucleation site for cell generation within the composite foam.

52. The method of claim 51, wherein the contacting comprises contacting the plurality of ss-PCM particles and the one or more pre-polymer reactants with a supercritical gas.

53. The method of claim 52, wherein contacting with the supercritical gas comprises contacting with one or more of carbon dioxide, cyclopentane, and isopentane.

54.-61. (canceled)

62. The method of claim 51, further comprising modifying the plurality of ss-PCM particles with an agent.

63. method of claim 62, wherein modifying with the agent comprises modifying with one or more of tridecafluoro-1,1,2,2-tetrahydrooctyl silane, glycidyl phenyl ether, 3-(trimethoxysilyl)-propyl methacrylate, 2-methacryloyloxyethylhexadecyldimethylammonium bromide, dibutyldimethoxytin, and sodium hypochlorite solution.

64. The method of claim 62, wherein modifying with the agent comprises modifying with a surfactant selected from an alkylammonium surfactant, a vinyl-ammonium surfactant, or combinations thereof.

65.-68. (canceled)

69. The method of claim 51, wherein providing the plurality of ss-PCM particles comprises providing the plurality of ss-PCM particles wherein each particle of the plurality of ss-PCM particles comprises a nanofiller and a phase change material.

70.-77. (canceled)

78. The method of claim 69, wherein providing the plurality of ss-PCM particles comprises providing each particle of the plurality of ss-PCM particles having a clay modified with an agent.

79. The method of claim 78, wherein providing the plurality of ss-PCM particles comprises providing each particle of the plurality of ss-PCM particles having the clay modified with an agent selected from at least one of tridecafluoro-1,1,2,2-tetrahydrooctyl silane, glycidyl phenyl ether, 3-(trimethoxysilyl)-propyl methacrylate, 2-methacryloyloxyethylhexadecyldimethylammonium bromide, dibutyldimethoxytin, and sodium hypochlorite solution.

80. The method of claim 78, wherein providing the plurality of ss-PCM particles comprises providing each particle of the plurality of ss-PCM particles having the clay modified with a surfactant selected from an alkylammonium surfactant, a vinyl-ammonium surfactant, or combinations thereof.

81.-100. (canceled)

101. A method of regulating the temperature of an article, the method comprising:
providing a thermostatic material, the thermostatic material comprising
a polymeric foam comprising a plurality of cells, and
a plurality of shape-stabilized phase change material (ss-PCM) particles,
wherein at least one of the plurality of ss-PCM particles resides within at least one of the plurality of cells, wherein the thermostatic material undergoes a phase transition as a surrounding temperature of the article approaches a phase transition temperature of the thermostatic material, and the thermostatic material exchanges heat with the article during the phase transition to regulate temperature of the article.

102. The method of claim 100, wherein providing a thermostatic material comprises providing a heterogeneous foam containing the plurality of ss-PCM particles.

103. The method of claim 101, wherein the providing a thermostatic material comprises providing a biodegradable material.

104-108. (canceled)

109. The method of claim 101, further comprising modifying the plurality of ss-PCM particles with an agent.

110. The method of claim 109, wherein modifying with the agent comprises modifying with at least one of tridecafluoro-1,1,2,2-tetrahydrooctyl silane, glycidyl phenyl ether, 3-(trimethoxysilyl)-propyl methacrylate, 2-methacryloyloxyethylhexadecyldimethylammonium bromide, dibutyldimethoxytin, and sodium hypochlorite solution

111. The method of claim 109, wherein modifying with the agent comprises modifying with a surfactant selected from an alkylammonium surfactant, a vinyl-ammonium surfactant or combinations thereof.

112.-115. (canceled)

116. The method of claim 101, wherein providing a thermostatic material comprises providing the plurality of ss-PCM particles including a nanofiller and a phase change material.

117.-151. (canceled)
